(19) United States
(12) Patent Application Publication
(10) Pub. No.: US 2026/0225715 A1
(43) Pub. Date: Aug. 6, 2026

(54) FIELD TREATMENT USING POWERED PARAFOIL AIRCRAFT

(71) Applicant: Precision AI Inc., Saskatoon (CA)

(72) Inventors: Daniel McCann, Regina (CA); Andrew Streett, San Clemente, CA (US)

(21) Appl. No.: 19/155,129

(22) PCT Filed: Feb. 9, 2024
(86) PCT No.: PCT/CA2024/050171

§ 371 Date: Aug. 8, 2025

Related U.S. Application Data
(60) Provisional application No. 63/484,210, filed on Feb. 10, 2023.

(51) Int. Cl. B64D 1/18; B64C 31/036; B64U 10/50; B64U 101/30; B64U 101/40; B64U 101/45

(52) U.S. Cl. CPC B64D 1/18; B64C 31/036; B64U 10/50; B64U 2101/30; B64U 2101/40; B64U 2101/45

(57) ABSTRACT

A parafoil aircraft is used as a field treatment delivery vehicle. Advantages are a relatively low airspeed to facilitate timed spraying over target areas of the field, ability to control flight to be close to the crop canopy, ability to carry a heavy cargo of treatment agent, short take-off and landing distance, and, unlike copter aircraft, limited turbulence caused by the parafoil aircraft that can interfere with targeted spraying over the field.

This application is a national stage entry pursuant to 35 U.S.C. § 371 of International Patent Application No. PCT/CA 2024/050171, filed on Feb. 9, 2024, which claims priority to U.S. provisional patent application no. 63/484,210, filed on Feb. 10, 2023, the contents of all of which are hereby incorporated by reference in their entirety.

### TECHNICAL FIELD

This patent application relates to field treatment systems, in particular to automated field treatment systems using aircraft.

### BACKGROUND

Agricultural product yields have increased in recent years due, in part, to chemical resistant crop varieties. Matching chemical resistant seeds with herbicides, pesticides, and fungicides amplifies crop output. The application of these herbicides, pesticides, and fungicides is typically accomplished either by aircraft or ground sprayers.

The aerial sprayers, or crop dusters, are typically manned aircraft that take off from remote airports filled with 950 to 2500 liters of chemical and traveling at speeds of 145 to 240 km/h. The aerial spraying activity is typically accomplished at heights around 3 m above the crop canopy.

The ground spraying equipment are typically manned machines that are stored at a central farm equipment area and are brought out to accomplish the spraying activity. The ground sprayers typically carry between 375 to 4500 liters of chemical and travel at speeds of 8-30 km/h. The ground spraying activity is typically accomplished at heights around 100 to 125 cm off the crop canopy.

The reason to spray chemical is normally a decision by the agronomist or farm owner when a known issue is present such as weeds, insects, or fungus. When the issue is identified the time to spray is immediately and is only limited by weather (wind, hail, rain, etc.), nighttime conditions, and the time it takes to fuel the aircraft and fly to that location.

The reason chemicals are not applied more frequently or on a set schedule is it can cost up to 70% of a farmer's operations during growing season, and the earth does not follow a set schedule for weeds, insects, and fungus issues with agricultural products. Additionally applying chemicals frequently to crops introduces chemical signatures in the final product which humans consume, can lead to environmentally harmful chemical runoff in earth's waterways, and drift of this chemical to other fields not using that particular chemical resistant crop can lead to devastating crop health and/or death of the neighboring crop.

Autonomous spraying, both aerial and ground application, has begun to emerge as a way of removing human and labor costs and allow the machines to work at daytime and/or nighttime when it can be dangerous for humans to do the same tasks. Machine learning has further enhanced this autonomous functionality by allowing the machines to identify the weeds, insects, and/or fungus in real-time effectively reducing the workload of the agronomist. The ability for autonomous machines to simultaneously sense only the issues within the crop and react to those issues alone could save farmers up to 70% of their costs per growing season by reducing the amount of chemical used by up to 90%.

Targeted delivery of treatment agents can use machine vision to recognize crops in need of treatment and controlled delivery systems to deliver treatment agents to only those areas that need treatment. The size of the minimum areas to be treated can be as small as a single plant, for example about 0.2 m² , with significant reductions in the cost of treatment agent used in a field and significant reductions in the possible contamination of soil and/or ground water due to the delivery of the treatment agents to the field.

Currently machine learning is limited by the processing speed of hardware, memory constraint of the hardware, and the end-to-end system latency from image capture to machine learning algorithm output that can be reacting upon. These limitations have previously limited machine learning for targeted delivery of treatment agents to only be applied to ground spraying applications as the precision machines only travel at 8-19 km/h. When treating a field with constant application of a treatment agent, or when the minimum treatment area size is about or greater than 1 m² , such ground machines can travel at speeds up to between 16 to 19 km/h. However ground machines reduce between 7%-9% of crop yield due to soil compacting and crop crushing, they can easily get stuck in muddy fields, and they are very expensive pieces of machinery that can cost upwards of $1M USD for an asset that has an effective lifetime of 10 years. Due to these limitations in end-to-end system performance of the machine learning, aerial applications are only just starting to become viable to the most elite teams in autonomous systems development.

Aerial herbicide and/or pesticide spraying of fields using fixed-wing aircraft is well known in the art of spraying an entire field. While such specially equipped aircraft can carry a reasonable weight of agents for dispersal, the airspeed is too high for targeted dispersal of agents as can be done with drones. Aircraft also require airstrips, and so the aircraft must travel back and forth from an airstrip to arrive with a load of treatment agent.

The use of drones equipped with vision and/or navigation systems for targeted delivery of field treatment agents are known in the art. Some examples are disclosed in Applicant's PCT patent application publications WO/2020/172756 and WO/2022/192988, the contents of which are fully incorporated herein by reference. Drones can hover or move slowly over a field while spray devices can be used to disperse agents targets to areas as small as a single plant.

Targeted delivery of field treatment agents using vision system equipped aircraft promises to reduce the use of treatment agents in agriculture while improving crop yields. While the treatment agents used with targeted delivery systems may not comply with organic farming standards, the reduction in the use of potentially harmful treatment agent for the quantity and quality of crop yield produced creates a class of agricultural produce that can have superior value to what can be achieved with organic farming practices.

In US patent publication US2002/0193914 to Talbert et al., there is described a remote control powered parafoil aircraft that has an option to support a boom with a number of field spraying nozzles. The aircraft can carry a tank, a valve and a plurality of nozzles on a discharge tube or bar. The aircraft can be used for agricultural spraying or dusting. As is illustrated in FIGS. 1 and 2 of Talbert et al., the motorized parafoil aircraft hangs from draft cables or lines at a considerable distance. The draft cables or lines are spooled on line reels that are remotely controlled to adjust a length of the draft cables used to change the shape of the parafoil for turning and altitude control.

This type of parafoil aircraft is recognized as being stable in moderate winds and easy to control. However, by design, the aircraft body is caused to swing and twist from the lines as the cables are used to control flight using the parafoil. While such swinging and twisting is not a problem for conventional parafoil flight, it makes conventional parafoil aircraft not suitable for targeted delivery of field treatment agents in which stability is important.

### SUMMARY

The ability to spray from the air is a major advantage when sensing a problem area, and then spraying only that problem area can be achieved essentially in real-time. However due to the limitations of machine learning and the end-to-end system performance, the optimal solution to reduce farming costs is a system maximizing the amount of chemical stored on-board in a single flight and flying as fast as the machine learning system can sense and the spray system can spray while hitting only the problem areas. Currently that means hundreds of gallons of storage, similar to the existing crop dusters, but only flying at 48 km/h to about 110 km/h (higher speeds may be possible). This class of aircraft is unique as most fixed wing aircraft that fly slower but carry hundreds of pounds are not a common set of requirements for production aircraft; this class of aircraft normally have really large wings to fly slower and carry this much weight. Such large wingspan aircraft can require larger airstrips and are more difficult to maneuver over a crop field.

The proposed solution uses low airspeed parafoil aircraft with aircraft body stabilization in which the speed of the aircraft flying over the field can be slow enough to allow for targeted delivery of treatment agents, the payload capacity can be scaled by scaling the size of the parafoil wing to carry a load of treatment agent over a thousand gallons, and the aircraft can take off and land from improvised airstrips much shorter than conventional airstrips for rigid wing aircraft. At such reduced airspeed and flying about 1 m above the crop canopy, systems for targeted delivery of sprayed agents from the aircraft are effective. Furthermore, such aircraft can be safely landed, even in an emergency, with no engine power.

A parafoil aircraft modified to provide aircraft body stabilization can be used as a field treatment delivery vehicle. Advantages can comprise one or more of: a relatively low airspeed to facilitate timed spraying over target areas of the field; ability to control flight to be close to the crop canopy; ability to carry a heavy cargo of treatment agent; short take-off and landing distance; and, unlike copter aircraft, limited turbulence caused by the parafoil aircraft that can interfere with targeted spraying over the field.

Powered parafoils that are suitably stabilized simultaneously solve all of the issues that are brought on by ground sprayers, crop dusters, autonomous systems, safety, cost, and do so within a flight speed and payload carrying capability that is required by the machine learning and optimized, efficient agricultural operations.

The proposed solution of using powered parafoil autonomous systems that sense weeds, insects, and fungus issues in real-time and then spray only those issues in real-time from the same platform pushes the boundaries of machine learning end-to-end system performance to provide the farmer with:
1) Increased speed of application from 10 km/h to more than 65 km/h for lower operational costs (more payload, longer endurance, less operators);
2) Simultaneously senses and sprays only the issue removing up to 90% of chemical application, leading to up to 70% reduction in yearly crop costs;
3) Reduces chemical run-off;
4) Reduces chemical signature on the final agricultural product;
5) Reduces drift to other neighboring crops;
6) Removes the 7%-9% yield reduction of ground sprayers;
7) Does not get stuck in muddy fields, wasting valuable time to address the issue;
8) Can be easily stored in a smaller footprint than ground sprayers or traditional crop duster sized aircraft, which leads to being able to store more of these platforms in the same existing footprint;
9) Can fly any time day or night (minus harsh weather events) for immediate sense and response, which could mean routine or more frequent flights over fields to handle issues sooner.

Unlike a traditional fixed wing aircraft, a powered parafoil can cut power in an emergency and safety land on the ground. It has vastly less type certification costs, which leads to drastically lower procurement costs, and a powered parafoil has the ability to sustain higher wing loading and therefore hold more chemical per flight in a smaller operational footprint and storage impact.

The proposed system and method can be multiple machine learning sensor-based, precision spraying capable, powered parafoils for precision agriculture dealing with weeds, insects and fungus issues in large crop areas. The benefits are lower operational costs to the farmer including chemical costs, platform costs, labor costs, and ultimately a scheduled or immediate response capable system that can be used across large acreage farms.

The proposed system may have several powered parafoils that act as a coordinated unmanned aerial system. The powered parafoils can be controlled by either a unique ground control station, or from a coordinated global headquarters ground control station. The control happens with a bi-directional wireless signal, either terrestrial (cell, radio, etc.) or satellite communications based signal. The ground control station has user interfaces that stream unique parafoil health data, issues, alerts, and emergency messages to the pilot in command at the ground control station while also streaming wireless command, control, and telemetry to the unique parafoil.

The proposed unique parafoil system may have three subsystems: the unmanned aerial vehicle, the sensor subsystem, and the sprayer subsystem. The unmanned aerial vehicle may have everything required to complete the safety-critical flight operations. It may include the vehicle structure, electronics, avionics, and radio equipment. The sensor subsystem includes everything non-flight critical required to sense the issue and signals to react to the issue such as camera systems, processing systems, and the machine learning subsystem. The sensor subsystem may also have GPS (global positioning system), IMU (inertial measurement unit), wind, and other environmental and positioning systems if the aircraft telemetry data is not sufficient. The spray subsystem may take the coordinated signals from the sensor subsystem and actively react to those non-flight critical signals by opening electronically controlled valves or operating other control electronics. It may also include the structures for carrying the chemical, deploying the chemical, and the electronics for storage and pressurization systems.

### BRIEF DESCRIPTION OF THE DRAWINGS

The invention will be better understood by way of the following detailed description of embodiments of the invention with reference to the appended drawings, in which:

FIG. 1 is a schematic front view of an embodiment of an autonomous powered parafoil field treatment aircraft having a spray nozzle boom;

FIG. 2 is a schematic front view of an embodiment of an autonomous powered parafoil field treatment aircraft having a vision system;

FIG. 3 is a schematic illustration of a field treatment system having a ground service vehicle, operator console, drone vision system and a parafoil aircraft equipped with a spray boom;

FIG. 4 is a schematic illustration of a field treatment system having a supply station for replenishing parafoil field treatment aircraft for treating a plurality of fields; and

FIG. 5 is a block diagram of an embodiment of an autonomous powered parafoil field treatment aircraft control system.

### DETAILED DESCRIPTION

There can be three subsystems to the autonomous aircraft: (1) aircraft subsystem, (2) vision subsystem and (3) spray subsystem. The aircraft subsystem deals with flight critical autopilots and flight critical structures. It includes the propulsion, fuel, and take-off/landing systems. The vision and spray subsystems are just payloads and do not need to be flight critical.

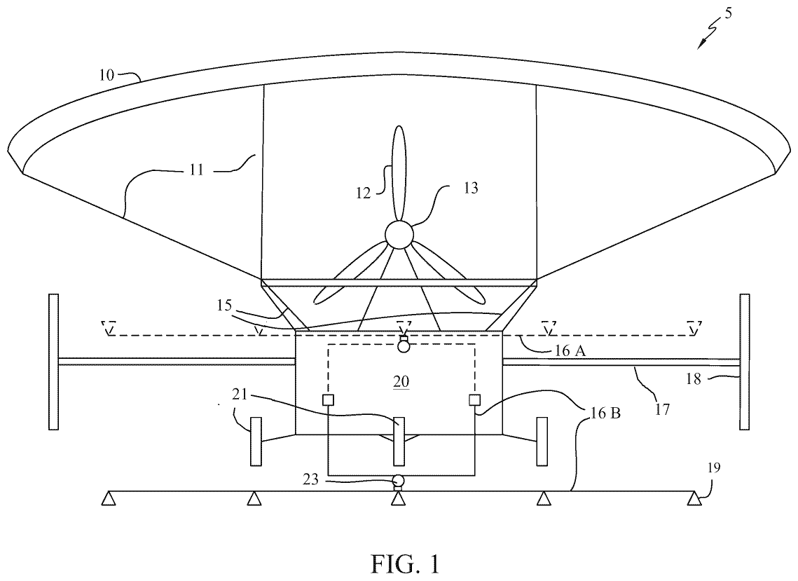

In the example of FIG. 1, the parafoil aircraft 5 comprises a parafoil wing 10 attached to a fuselage 20 or body of the aircraft by draft cords 11. At least some of the draft cords 11 can be used as control cables 15 connected to actuators 15A for controlling a shape of the parafoil 10 during flight and thus for steering or controlling the flight of the aircraft 5. Within the fuselage 20, a cockpit (not shown) may be included for the aircraft 5 to have a pilot, however, a cockpit is omitted when the aircraft is fully autonomous or semi-autonomous/remotely controlled. One or more motors 13 and propellers 12 are provided for propulsion. Each motor 13 can be a combustion engine using fuel or an electric motor using battery power. A fuel combustion engine provides for good energy density and can be more efficient than an electric motor with battery power storage. When driven landing gear 21 are used, it can be efficient to provide electric motor drive for the landing gear 21, while using a fuel combustion engine for the propeller 12, since the electric drive is only used briefly during take-off and the need for battery storage can be reduced. Preferably, the propellers 12 are arranged with respect to spray nozzle(s) 19 so as to avoid the air currents created by the propellers 12 from adversely affecting the direction of flow of sprayed agents onto the field.

A notable distinction between the parafoil aircraft 5 shown in FIG. 1 and a conventional parafoil aircraft is the addition of aircraft body and/or spray nozzle stabilization to prevent or to control the way in which the parafoil aircraft body sways and/or twists while hanging from the parafoil cables or cords 11. FIG. 1 shows an example in which one or more vertical airfoils (sway control surfaces 18) act like rudders that can be actively controlled to stabilizing side to side swaying during flight. Twisting or yaw motion can be controlled using a yaw control actuator 23 connecting the spray boom 16 to the fuselage 20. The actuator can also be used to compensate for any roll motion, however, roll motion is not as great. Horizontal airfoils 17 can be provided, like those connected to the vertical airfoils 18 in FIG. 1, to be used as flaps to control yaw and roll.

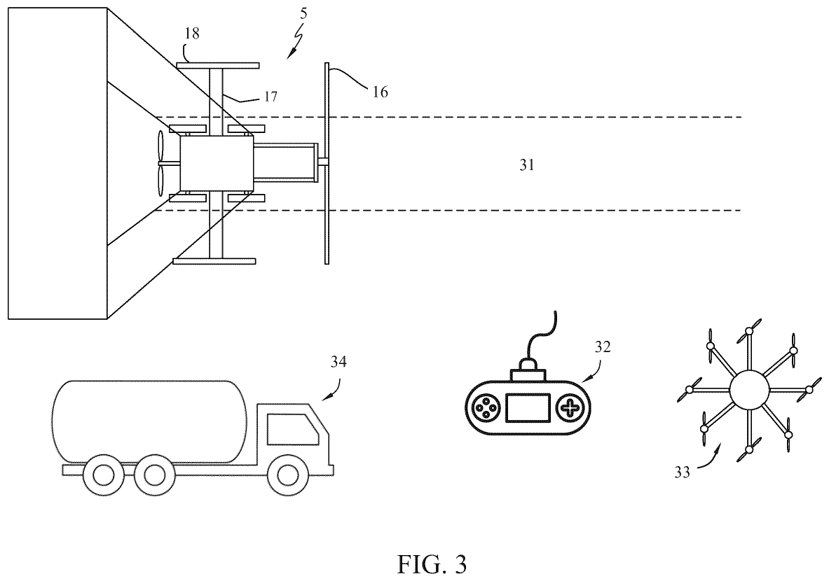

While the airfoils 17, 18 are illustrated in FIGS. 1 and 3 as being located near the center of gravity of the aircraft body, it will be understood that they can be located aft or astern to be like a tail or a canard wing, as long as any wash or airflow disturbance caused by the stabilizing airfoils do not interfere with the operation of spray boom 16. Stabilization may also be provided directly to the spray boom 16, as long as the stabilization does not adversely affect spraying.

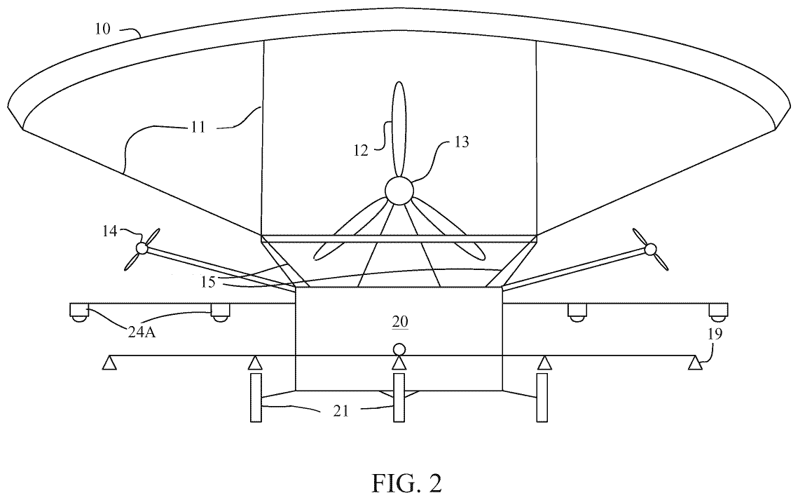

While the stabilization can be achieved through the use of airfoils, in the embodiment of FIG. 2, active stabilization rotors 14 are shown that can be used to provide variable levels of thrust and/or drag in a desired direction so as to provide the required stabilization of the aircraft body so that the spray boom 16 can maintain a substantially constant horizontal position that extends orthogonally to the direction of flight. The stabilization rotors 14 (similar to copter rotors) may be driven by electric motors drawing power from a battery or from a generator driven by the combustion engine driving the main thrust propeller 12 or propellors. While the stabilization rotors 14 are shown to be providing horizontal thrust, they may be rotated to provide vertical thrust. In some embodiments, the stabilization rotors 14 may be mounted on rotatable joints so that the direction of thrust can be changed as needed.

If the aircraft is light enough, it can be convenient for one or more operators to launch the aircraft into flight by carrying the fuselage 20 while jogging/running with it to cause the parafoil 10 to deploy. The motor propulsion can then continue the flight. However, operator-carried launching would limit the aircraft weight to about 35 kg and may only be practical in special applications. Landing can be achieved by turning off the motor propulsion and allowing the parafoil 10 to support the fuselage 20 until landing. Landing gear 21 can be optional.

When the aircraft is heavier, takeoff and landing using landing gear 21 can be done with no operator assistance except for any required assistance in deploying the parafoil 10. If the propeller 12 interferes with the draft cords 11, it will be appreciated that the parafoil 10 needs to be aloft prior to powering the propeller 12. This can be achieved by providing motor power to the landing gear 21 (i.e., driving the wheels) to move the aircraft on the ground to deploy the parafoil 10. See for example U.S. Pat. No. 9,884,530 that describes a parafoil quad passenger aircraft, the content of which is incorporated herein by reference.

The sprayer system 25 can have any number of nozzles 19 and such nozzles can be individually controlled if desired. When the treatment agent is a liquid, one or more pumps can pressurize the treatment agent from the treatment reservoir 44 to supply the nozzles 19. Valves, such as solenoid valves, can be used to control the flow of the liquid agent to the nozzles. In the case of a granular or powder treatment agent, gravity feed or motorized feed/auger screws (or the like) can be used to disperse the agent.

As shown in the example of FIG. 1, there may be five spray nozzles 19 arranged along a boom 16 attached to the fuselage 20 using arms that can be raised or lowered. Each spray nozzle 19 can be independently controlled to release a treatment agent to a localized area for targeted spraying or delivery of treatment. The number of nozzles or dispensers can be fewer or greater than five as illustrated. The spray boom 16 can range from 2 m to 8 m or more, and nozzles may be spaced apart by about 15 cm to about 60 cm.

In the embodiment of FIG. 2, a vision system for assessing the treatment needs of the field is included in the treatment aircraft. The vision system preferably uses a number of cameras 24A mounted to the fuselage 20.

As illustrated in FIG. 3, a ground service vehicle 34 can be a van or a truck that can pull a trailer carrying the parafoil aircraft 5. The ground service vehicle 34 can be driven to an access road of or near to the field or fields to be treated. The access road can also serve as an improvised airstrip 31. A parafoil aircraft 5 may need about 25 m to land, and about 30 m to take off. Refueling of the parafoil aircraft 5 can also be done using a fuel supply carried by the ground service vehicle 34.

Using the field treatment system typically will involve first defining the treatment needs of the agricultural field or fields to be treated. In the embodiment of FIG. 3, the system may include a vision system drone 33 that can be used by an operator to fly over a field for reconnaissance to identify the needs for treatment of the field. Once the drone 33 has identified possible issues, an operator can select a treatment. The treatment can be a targeted treatment for problems that are at isolated locations, or the treatment can cover a larger area where the field needs the same treatment. In some cases, a treatment can involve applying a fertilizer, and the amount of fertilizer needed might be variable over the field. A treatment map is followed by the aircraft to apply the treatment agent. A treatment plan can involve applying different treatment agents and may involve a number of flights over the same field.

In accordance with the treatment plan, the operator may fill the tank or reservoir 44 of the parafoil aircraft 5 with a supply of a selected treatment agent (whether liquid or granular). The definition of the treatment flight plan is recorded in the memory of the treatment system on board the treatment aircraft. The treatment aircraft then is flown at about 1-3 m above the canopy of the crops in the field to execute the treatment agent dispersal or spraying. When a field borders a road, forested area or an area with tall buildings, the parafoil aircraft can offer the tightest of turning radii among horizontal-flight aircraft, namely about 25 m to 50 m.

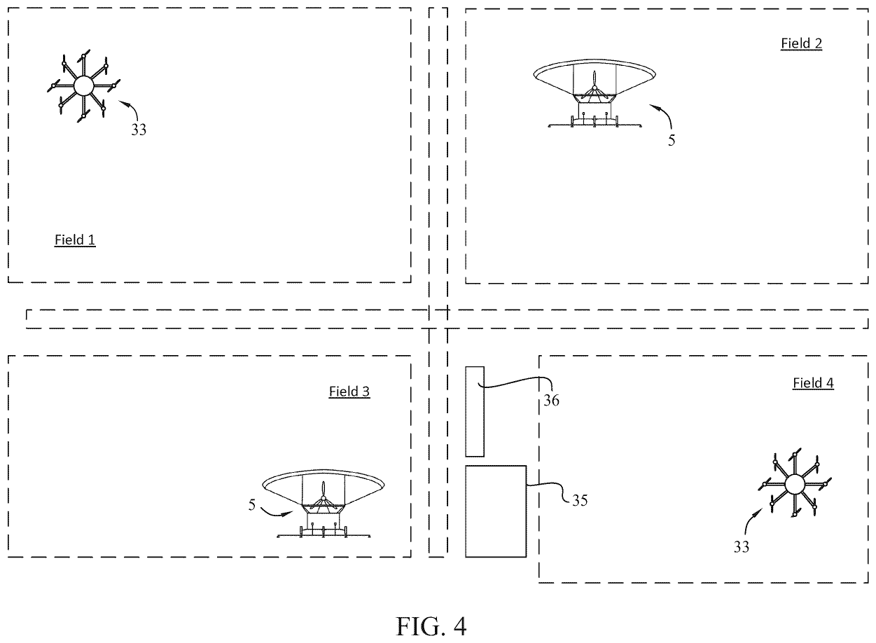

FIG. 4 illustrates an embodiment in which the parafoil aircraft 5 is used to treat a large area, for example a number of fields. A number of treatment aircraft may be deployed, for example for distributing different treatment agents to the same field. As described above, a parafoil aircraft 5 can carry significant payloads, enough for targeted treatment of multiple fields. The distance between the launch site and the fields to be treated is not limited to immediately adjacent fields, and the autonomous or human-piloted treatment aircraft can fly the distance required to reach the field to be treated.

In the system illustrated in FIG. 4, there may be as many treatment aircraft as desired. Preferably, there is a treatment aircraft 5 for each treatment agent. While drones 33 are illustrated to provide the vision system separate from the treatment aircraft, as mentioned above, the vision system can be included in treatment aircraft if desired. While autonomous treatment aircraft can manage flight over the canopy of a field to control the release of treatment agents in accordance with the treatment plan, it will be appreciated that a human operator can be used as well. For example, an operator may be dispatched to the field being treated, for example to field 2 in FIG. 4, and may be required to signal to the treatment aircraft to begin treatment. By providing the operator at the field with the ability to signal to the treatment aircraft to abort treatment, for example because the operator is observing the wind conditions are not favorable or because the operator sees a potential interference, such as irrigation sprinklers starting operation, or people, animals or vehicles approaching the area of the field, accident prevention and/or efficiency of treatment can be enhanced without resorting to complex automated sensor and/or detection systems.

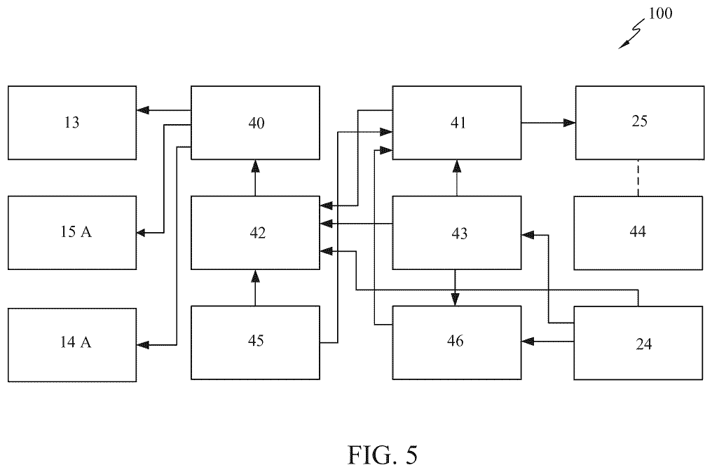

FIG. 5 illustrates a block diagram of the control system 100 onboard the fuselage 20. A flight controller 40 controls, for example, control motors 13 that have spools of control cable 15 for relaxing and shortening draft cords 11 of the parafoil. The flight controller 40 also controls the motor speed of the propulsion system, e.g. one or more propellers 12. The flight controller 40 can comprise an altitude sensor, such as radar or lidar for low altitude flight over a field as well as a compass for sensing a direction of flight. The flight controller 40 can receive signals from the navigation system 42 to define the desired direction and altitude. Inertial sensors or IMU's (either separate or integrated into the positioning system 45) can be used to determine the aircrafts motion so that the flight controller 40 can signal to the stabilizing controls 14A an appropriate response. In the case of active stabilization rotors 14, rotor speeds can be controlled to limit yaw or twisting. In the case of airfoil flaps 17/18, actuators can be controlled to create lift and/or steering forces.

If the flight controller 40 allows for the airspeed to be controlled, then the navigation system 42 can specify the desired airspeed. The measurement of the current airspeed is best determined by a combination of the positioning system 45 and the vision system 24, and thus, the current airspeed measurement can be provided to the flight controller 40 from the navigation system 42 or separate airspeed sensors can be included within the flight controller 40. It will be appreciated that the navigation system 42 can be operatively connected to the treatment control system 41 to receive flight path data and operatively connected to the flight controller 40 to provide control signals to the motor 13 and propulsion system to follow a flight path defined by the flight path data. In this way, the aircraft can be entirely autonomous from take-off to landing while respecting the treatment plan. If desired, the aircraft can also accommodate a pilot for manual override purposes.

The vision system 24 (with machine learning/AI) used to sense weeds, pests, or fungus can be part of the treatment aircraft, or it can be separately provided on a smaller aircraft, such as a drone 33 as shown in FIG. 3. When the vision system 24 is separated from the treatment aircraft, the treatment aircraft can also have a vision system 24 that can be used for guiding the targeted delivery of treatment agents instead of relying on GPS or other positioning systems 45. The vision system 24 used to sense weeds, pests, fungus or crop development stage can be connected to an operator system for planning field treatment. The vision system 24 can be a vision-based system utilizing several cameras 24A (for example orthogonal to the direction of travel). The vision system 24 can include cameras 24A (preferably including an individual or a combination of visible, infrared and/or ultraviolet imaging), camera sensor processors, a central processing unit with machine learning/AI processing hardware, and memory to save images and post-processed spray prescriptions. This subsystem may also include high resolution attitude (9 DOF=translation, rotation, heading), altitude (GPS and barometer), wind speed (pitot and ground speed), and ground distance (lidar, radar, etc). This telemetry can be passed along with the prescription to the spray subsystem.

The spray subsystem 25 may include the same 9 DOF attitude system, altitude, wind speed, and ground distance subsystems. These can be independent as the vision and spray subsystems do not need to be located at the same location on the aircraft subsystem-they may be translated and rotated from one another. The vision subsystem 24 may pass telemetry and spray prescription (series of GPS points) to the spray subsystem 25. The spray subsystem 25 may be made up of the chemical tank, pumps, valves, and nozzles 19 to dispense the chemical to the ground in a precision manner. “Precision” should be defined as any area as small as 30 cm by 30 cm to 3 m by 3 m (but not limited to these definitions). Depending on the “spot” of precision spray laid on the ground, the nozzles 19 may be spaced out to reduce overlap (if that is desired).

The vision system 24 is used to define what issues can be identified in the field. A treatment plan can take the form of a map that can define which areas of the field are to receive a given treatment agent. The spray subsystem 25 (or the granular agent dispenser) can use the map to determine where treatment agent is to be sprayed or dispensed. The treatment control system 41 can record in memory what portions of the map have received the treatment agent. Since the aircraft may not be able to follow a straight flight path, the treatment control system 41 can spray or dispense to only those portions that have not received treatment agent according to the record in memory and that the map indicates there is a need for treatment agent. The aircraft 5 can make multiple passes over the field without risk of doubling the amount of treatment agent to any one area while ensuring that the treatment plan is completed by delivering treatment agents to all portions identified in the map.

The targeted treatment plan may define a large number of isolated target areas within a field for receiving a treatment agent separated from one another by surrounding areas within the same field not receiving the treatment agent. The isolated target areas can include a minimum target area as mentioned above from as small as about 30 cm by 30 cm to about 5 m². The targeted field treatment system 41 of the parafoil aircraft 5 can be adapted to deliver the treatment agent in a manner that delivers an effective amount of the treatment agent to the isolated target areas while delivering an ineffective or non-harmful amount of the treatment agent to the surrounding areas.

The control interface 43 of the aircraft system can wirelessly communicate with an operator console 32 used on the ground. It will be appreciated that prior to any treatment, it is preferred to conduct reconnaissance flights to build a map of the field useful for detailed navigation and to image the field to identify pests or disease to devise a treatment plan for the field. Ingesting existing planting machine GPS coordinates (geofence and crop row plant locations) can be done to provide a starting point for the vision system 24 that will identify crops and/or weeds in addition to their conditions. Such flights can be done using operator guidance to define a general flight path, although the vision system 24 can be used to identify which parts within an area of a field have not been adequately imaged so that the navigation system 42 can be instructed to cause the aircraft to pass over such parts again.

Once the treatment plan is decided by the operator (or using an algorithm responding to operator defined rules), the treatment control system 41 commands the navigation system 42 to fly the aircraft over areas needing treatment. Using precision location information from the positioning system 45 (in some cases this can include the vision system 24), the treatment control system 41 controls the sprayer system 25 to treat the field in accordance with the treatment plan.

While the treatment reservoir 44 is illustrated in FIG. 5 as being a single reservoir, it will be appreciated that two or more reservoirs can be provided on the aircraft 5. The treatment plan can accordingly involve treatment using plural treatment agents during the same flight. The spray system 25 can be a single spray system with the treatment fluids or solutions being selected using valves for spraying. In such as case, it is preferred to have the valves located close to the spray nozzles 19 so as to not require a long purge when switching from one treatment liquid to another. Alternatively, two or more arrangements of treatment nozzles may be provided such that each arrangement is dedicated to a single treatment solution. Mixing of liquids using a mixing valve or mixer is also possible. When the treatment 20 product is a powder, the spray system may release powder (for example using air pressure to eject the powder), but preferably the powder is mixed with a liquid, such as water, prior to spraying.

It will be appreciated that some types of treatment may require flight speeds as low as about 30 km/h to be effective, while others may be performed at higher speeds, such as around 60 km/h to about 100 km/h. The greater airspeed that can be used efficiently is preferred since the time to treat the field is reduced. As previously mentioned, airspeed can be defined by the choice of parafoil 10 or the parafoil can be controlled to vary the airspeed.

It will be appreciated that the aircraft 5 can be adapted to carry an operator if desired. When the aircraft is designed to carry a payload of more than 200 kg, it can be considered a safety feature to allow an operator to override automated controls in case of a control system failure since the aircraft could do damage, for example to a building or powerlines, on the ground.

It will be appreciated that the above description refers to a parafoil aircraft. The term “parafoil aircraft” is intended to include horizontal flight aircraft able to carry payloads over 50 kg, use airspeeds lower than 50 mph while making use of an improvised (i.e. short) airstrip 31 with a take-off and landing distance less than about 75 m. This can include auto-gyro aircraft and soft-wing fixed-wing aircraft that include parafoil wing and delta-wing (hang-glider-like) aircraft, however, in most cases, a parafoil wing is best suited for the purpose.

What is claimed is:

1. A field treatment aircraft comprising:
a parafoil wing; and
a body connectable to the parafoil wing by a number of cables, the body supporting:
a treatment agent reservoir;
a positioning system;
a treatment control system responsive to treatment plan data and said positioning system;
a treatment agent spraying system connected to said treatment agent reservoir and responsive to said treatment control system to provide for targeted treatment of a treatment agent to a field; and
a motor and propulsion system.

2. The aircraft as defined in claim 1, further comprising a stabilization system operable to reduce an effect of sway and/or twist motion of said body hanging from said parafoil wing during flight to stabilize said treatment agent spraying system.

3. The aircraft as defined in claim 2, wherein the stabilization system comprises a plurality of controllable stabilization airfoils connected to said body.

4. The aircraft as defined in claim wherein the stabilization system comprises a plurality of controllable rotors.

5. The aircraft as defined in claim 1, wherein said treatment agent spraying system comprises at least one boom supporting a plurality of spray nozzles in a transverse direction to a direction of flight of said aircraft, each of said spray nozzles dispersing treatment agent to cover a given width on said field.

6. The aircraft as defined in claim 5, further comprising an actuator for raising and lowering said at least one boom.

7. The aircraft as defined in claim 5, wherein said spray nozzles are individually controlled using controllable valves, said treatment control system being connected to said controllable valves.

8. The aircraft as defined in claim 5, wherein the stabilization system comprises at least one stabilization actuator connected to said at least one boom.

9. The aircraft as defined in any one of claim 1, further comprising wheeled landing gear.

10. The aircraft as defined in claim 9, wherein said motor is operably connected to said landing gear to propel said aircraft for take-off.

11. The aircraft as defined in claim 9, further comprising a landing gear drive connected to said landing gear to propel said aircraft for take-off.

12. The aircraft as defined in claim 1, further comprising a cockpit for a pilot.

13. The aircraft as defined in claim 1, further comprising a navigation system and a flight controller, the navigation system being operatively connected to the treatment control system to receive flight path data and to the flight controller to provide control signal to the motor and propulsion system to follow a flight path defined by the flight path data.

14. The aircraft as defined in claim 1, further comprising a vision system for imaging a field.

15. The aircraft as defined in claim 14, wherein said positioning system is configured to use data from said vision system to determine a position of said aircraft over the field.

16. A field treatment system comprising:
one or more field treatment aircraft as defined in claim 1;
one or more vision systems provided on said treatment aircraft or on separate vision aircraft; and
a treatment plan processor operatively connected to said one or more vision systems and generating said treatment plan data for the delivery of treatment agents to one or more fields.

17. The field treatment system as defined in claim 16, further comprising an operator console operatively connected to said treatment plan processor for approving and/or defining said treatment plan.

18. The field treatment system as defined in claim 16 or 17, wherein said one or more field treatment aircraft are two or more in number.

19. The field treatment system as defined in claim 16, wherein said one or more vision systems are integrated into said one or more field treatment aircraft.

20. The field treatment system as defined in claim 16, wherein said one or more vision systems are integrated into drone aircraft.

21. A method of field treatment comprising:
providing a parafoil aircraft adapted with a targeted field treatment system and a supply of at least one treatment agent;
imaging a field using a vision system on said parafoil aircraft or on a separate aircraft;
determining a targeted treatment plan for said field using data obtained from said vision system;
providing said treatment plan to the targeted field treatment system of said parafoil aircraft, supplying said treatment system of said parafoil aircraft with a supply of treatment agent; and
flying said parafoil aircraft over a canopy of said field and causing said treatment system of said parafoil aircraft to deliver said treatment agent in accordance with said treatment plan.

22. The method as defined in claim 21, wherein said imaging said field comprises images a plurality of fields, said determining said treatment plan comprises determining a treatment plan for each of said plurality of fields, and said flying comprises flying said parafoil aircraft to deliver said treatment agent to said plurality of fields.

23. The method as defined in claim 22, wherein said providing comprises providing a plurality of said parafoil aircraft each with a supply of a different treatment agent, said flying comprising flying each of said plurality of parafoil aircraft to treat with a different treatment agent each of said plurality of fields.

24. The method as defined in claim 21, wherein the targeted treatment plan defines a large number of isolated target areas within a field for receiving a treatment agent separated from one another by surrounding areas within the same field not receiving said treatment agent, said isolated target areas including a minimum target area smaller than 5 m², and said targeted field treatment system of said parafoil aircraft is adapted to deliver said treatment agent in a manner that delivers an effective amount of said treatment agent to said isolated target areas while delivering an ineffective or non-harmful amount of said treatment agent to said surrounding areas.

25. The method as defined in claim 24, wherein said minimum target area is smaller than 1.5 m².
